(19) United States
(12) Patent Application Publication
(10) Pub. No.: US 2016/0052768 A1
(43) Pub. Date: Feb. 25, 2016

(54) EXPANDABLE FUNNEL

(71) Applicants: Matthew J. Schmidt, Appleton, WI (US); Nicolaas T. Bressers, Milwaukee, WI (US)

(72) Inventors: Matthew J. Schmidt, Appleton, WI (US); Nicolaas T. Bressers, Milwaukee, WI (US)

(21) Appl. No.: 14/467,757

(22) Filed: Aug. 25, 2014

(51) Int. Cl. B67C 11/02

(52) U.S. Cl. CPC B67C 11/02

(57) ABSTRACT

An expandable funnel assembly for use with a fluid storage tank defining a volume and having an inlet in fluid communication with the volume. The expandable funnel assembly includes a mouth coupled to the tank and operable to direct fluids to the inlet, the mouth being adjustable between a first configuration, where the mouth provides a first target area, and a second configuration, where the mouth provides a second target area different than the first target area.

### FIELD OF THE INVENTION

The present invention relates generally to a funnel; and more specifically an expandable funnel.

### BACKGROUND OF THE INVENTION

When filling a storage tank from an external container or hose it can often be difficult to pour the contents of the external container into the tank without causing the contents to spill. Spillage, in these situations, is both wasteful and potentially harmful for the surrounding environment. This is especially true when harmful chemicals, such as gasoline or oil, are used near environmentally vulnerable areas, such as lakes, streams, lawns, and the like.

To combat this inefficiency, many users must obtain a separate, independent funnel to help direct the contents of the external container into the storage tank. However, this too can be cumbersome. In addition to requiring an additional set of hands to maintain the funnel in the proper position during pouring, the user must have access to the funnel in the first place and then must locate a place to store the funnel after the process is complete.

Furthermore, users of a standalone funnel must compromise between proper tank ventilation and a tight fight between the funnel and the opening of the storage tank. Generally speaking, the user must either accept pour slowing and a sturdy funnel or faster pouring with an unstable funnel. In situations where proper ventilation is achieved, it is often necessary to solicit help from a second person to hold the funnel in place while the first person pours the contents of the external container.

### SUMMARY OF THE INVENTION

In one aspect, the invention provides an expandable funnel assembly for use with a fluid storage tank defining a volume and having an inlet in fluid communication with the volume. The expandable funnel assembly includes a mouth coupled to the tank and operable to direct fluids to the inlet, the mouth being adjustable between a first configuration, where the mouth provides a first target area, and a second configuration, where the mouth provides a second target area different than the first target area.

In another aspect, the present invention provides an expandable funnel assembly for use with a fluid storage tank defining a volume. The expandable funnel assembly includes a frame couplable to the tank and defining an axis and a channel in fluid communication with the volume, the channel having a top end and a bottom end opposite the top end. The expandable funnel also includes a carriage coupled to the frame and axially moveable within the channel between a first position, proximate the top of the frame, and a second position proximate the bottom of the frame, and a mouth coupled to the carriage and adjustable between a first configuration, wherein the mouth provides a first target area, and a second configuration, wherein the mouth provides a second target area smaller than the first target area.

In still another aspect, the present invention provides an expandable funnel assembly for use with a fluid storage tank defining a volume and having a threaded nipple in fluid communication with the volume, where the threaded nipple defines a first thread diameter. The expandable funnel includes a frame removably couplable to the fluid storage tank, the frame having a first wall configured to threadingly engage the threaded nipple and a second wall forming external threads having a second thread diameter that is substantially similar to the first thread diameter, and a mouth coupled to the frame and adjustable between a first configuration where the mouth provides a first target area, and a second configuration, where the mouth provides a second target area different than the first target area.

### BRIEF DESCRIPTION OF THE DRAWINGS

FIG. 1 illustrates a fluid storage tank with an expandable funnel assembly.

FIG. 2a illustrates the expandable funnel assembly of FIG. 1 in a deployed configuration.

FIG. 2b illustrates the expandable funnel assembly of FIG. 2a with the mouth removed for clarity.

FIG. 3a illustrates the expandable funnel assembly of FIG. 1 in a stowed configuration.

FIG. 3b illustrates the expandable funnel assembly of FIG. 3a with the mouth removed for clarity.

FIG. 3c illustrates the expandable funnel assembly of FIG. 3b with a cap installed.

FIG. 4 is a top view of the expandable funnel assembly of FIG. 2a.

FIG. 5 is a top view of the expandable funnel assembly of FIG. 3a.

FIG. 6 is a section view taken along line 6-6 of FIG. 2a.

FIG. 7 is a detailed view of a funnel rod of the expandable funnel assembly of FIG. 1 in a first position.

FIG. 8 is a detailed view of the funnel rod of FIG. 7 in a second position.

FIG. 9a illustrates a second embodiment of a fluid storage tank having a threaded nipple.

FIG. 9b illustrates a second embodiment of a base frame installed on the fluid storage tank of FIG. 9a.

FIG. 10 illustrates the expandable funnel assembly of FIG. 1 with an adapter sleeve.

### DETAILED DESCRIPTION

It is to be understood that the invention is not limited in its application to the details of construction and the arrangements of the components set forth in the following description or embodiments, or illustrated in the drawings. The invention is capable of other embodiments and of being practiced or being carried out in various ways. Also, it is to be understood that the phraseology and terminology used herein is for the purpose of description and should not be regarded as limiting.

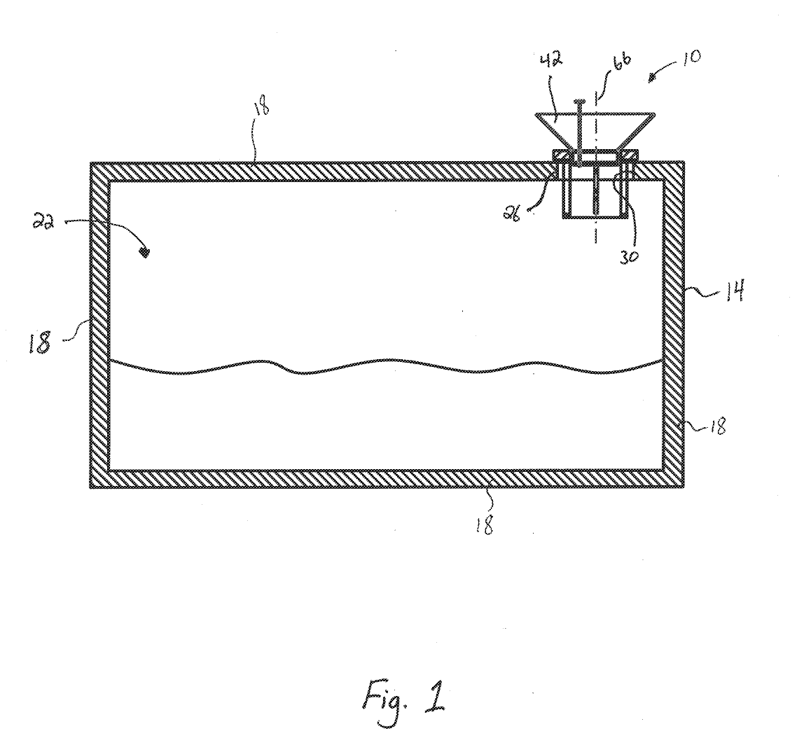

FIGS. 1-6 illustrate an expandable funnel assembly 10 for use with a fluid storage tank 14 to limit spillage and increase the ease at which fluids may be poured into the tank 14. In the illustrated construction, the fluid storage tank 14 is formed from one or more walls 18 joined together to form a fluid-tight volume 22. The fluid storage tank 14 also includes an inlet 26, formed in at least one of the walls 18 and configured to provide fluid access to the volume 22. In the illustrated construction, the inlet 26 defines an inlet diameter 30 and includes a set of internal threads 34 sized to engage the funnel assembly 10. During use, fluids, such as gasoline, engine coolant, motor oil, water, and the like, may be poured into the volume 22 via the inlet 26 and the funnel assembly 10.

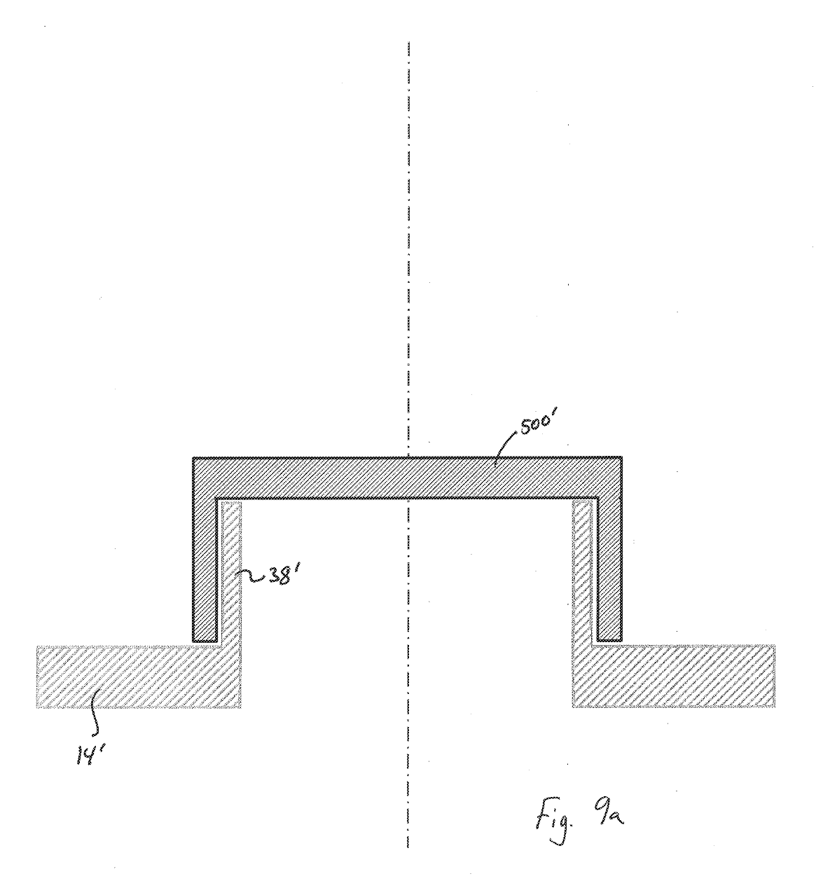

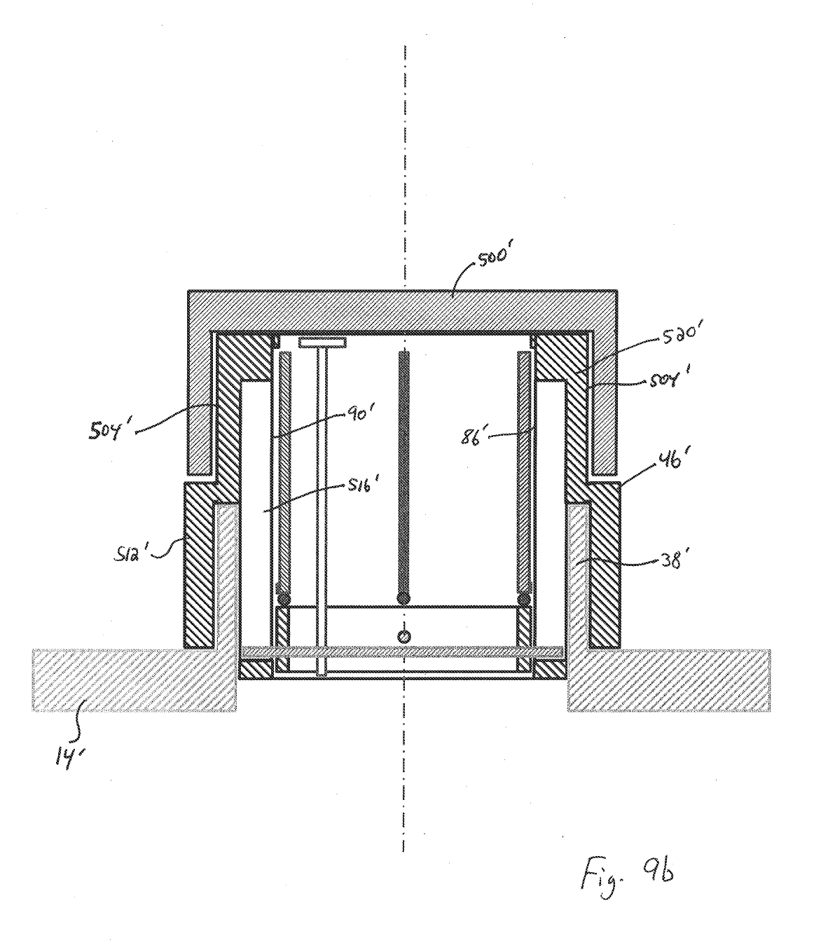

In alternate embodiments, the inlet 26 of the tank 14 may include an elongated tube (not shown) extending from the tank 14 to provide a distal end to which the funnel assembly 10 may be attached. In still other embodiments, the inlet may include a threaded nipple 38 extending from at least one of the walls 18 (FIG. 9).

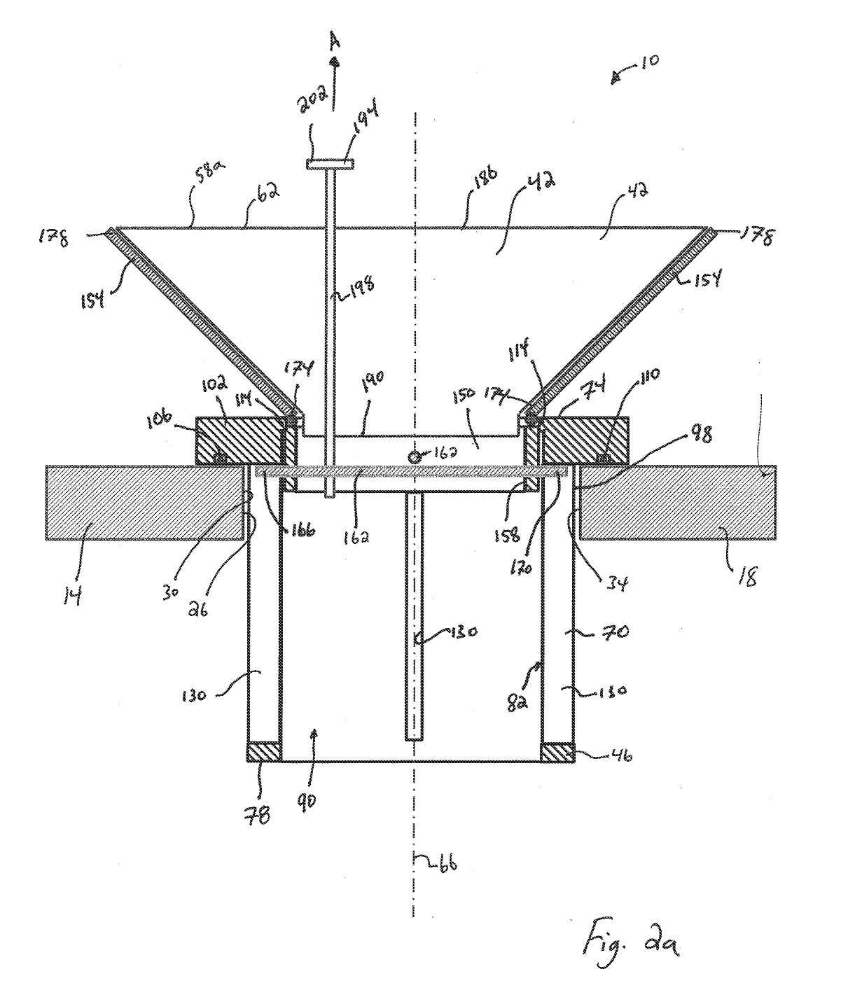

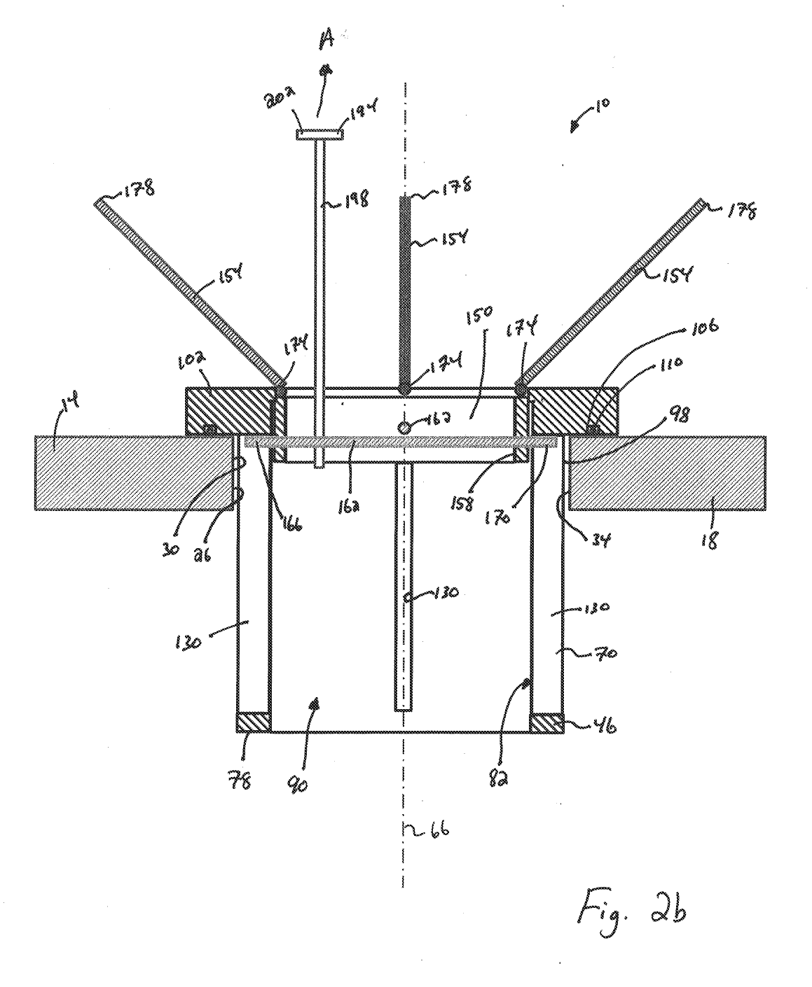

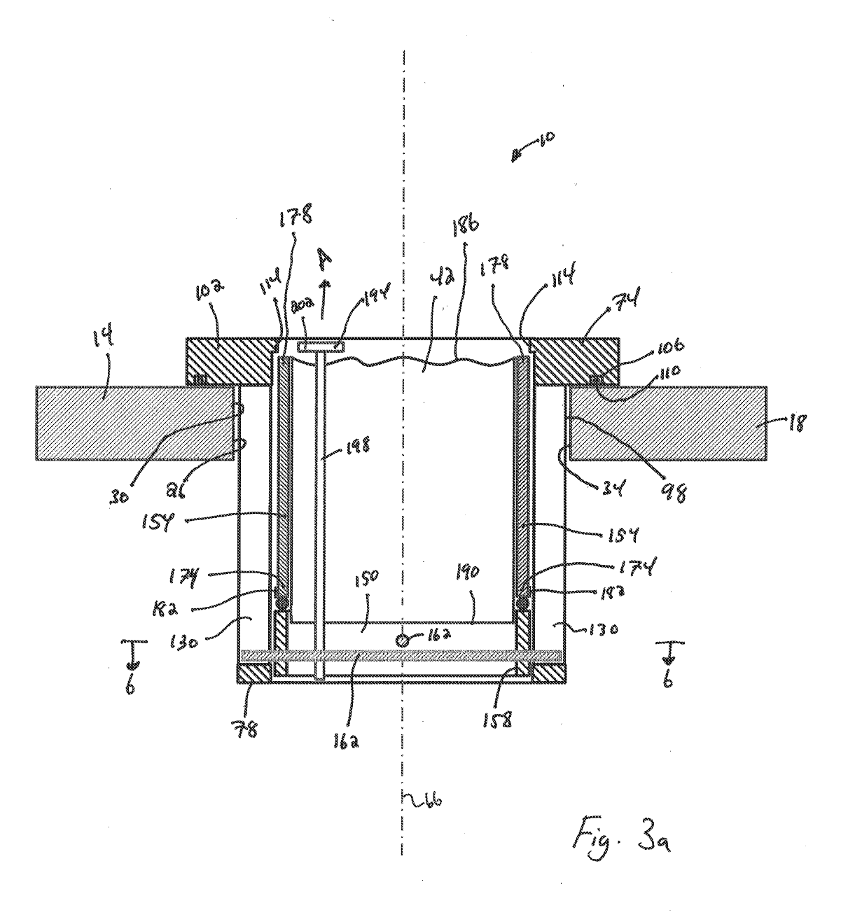

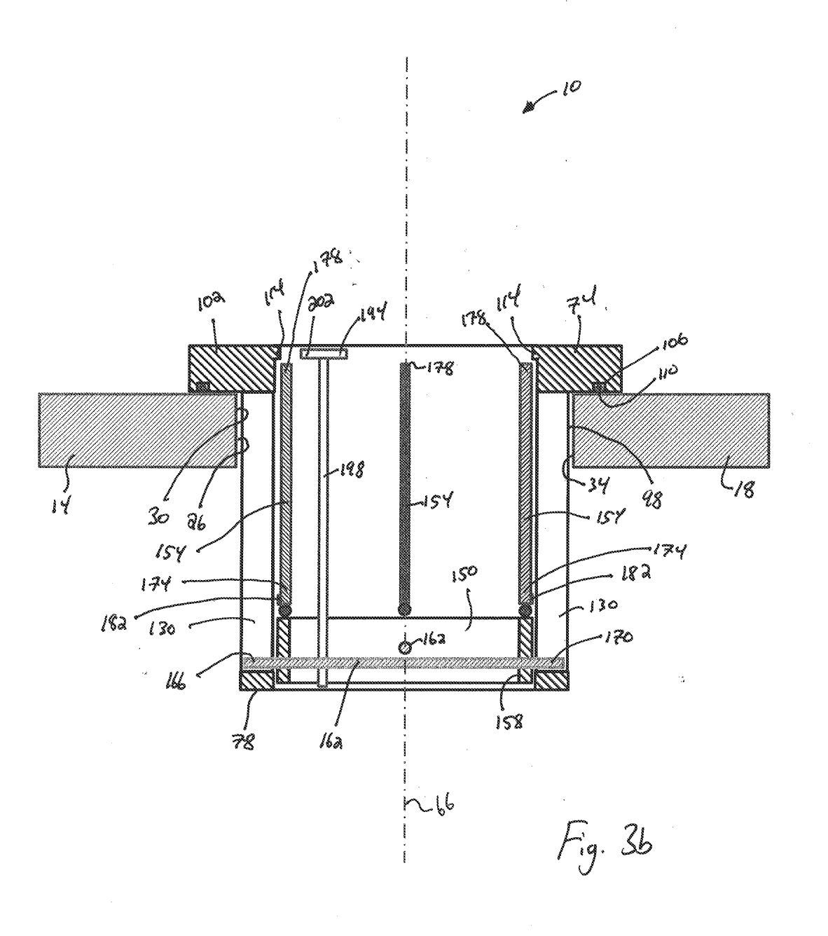

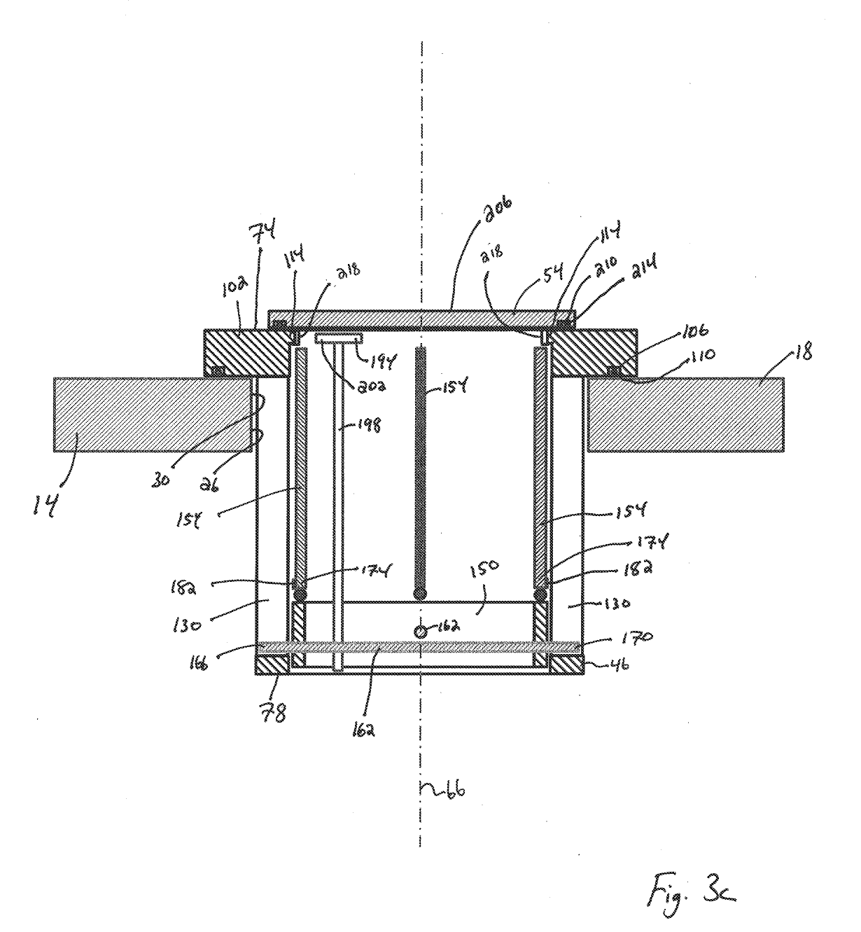

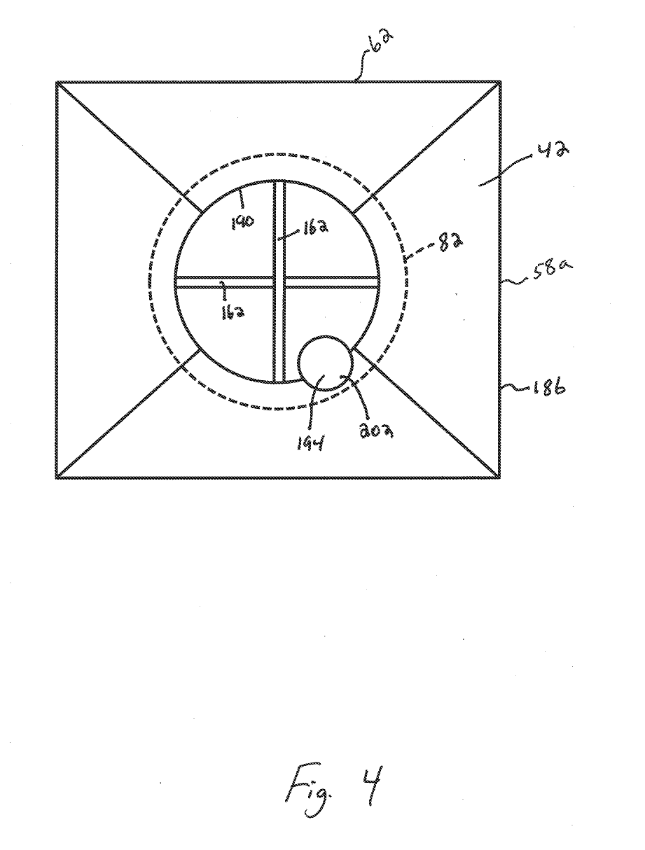

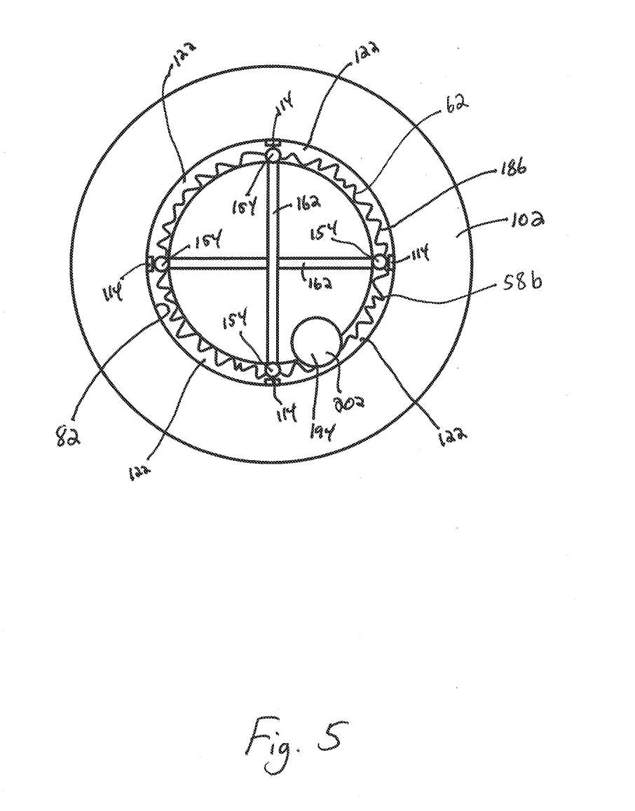

Illustrated in FIGS. 1-3c, the expandable funnel assembly 10 is coupled to the inlet 26 of the fluid storage tank 14 and configured to collect fluid, poured into the funnel's mouth 42, and direct that fluid through the inlet 26 and into the volume 22. In the illustrated embodiment, the expandable funnel assembly 10 includes a base frame 46 mounted to the tank 14 and defining a central axis 66, a funnel frame 50 movably coupled to the base frame 46, and a cap 54 removeably coupled to the base frame 46. During use, the funnel assembly 10 is adjustable between a deployed configuration (FIGS. 2a and 2b), where the funnel mouth 42 produces a first target area 58a (FIG. 4), and a collapsed or stowed configuration (FIGS. 3a-3c), where the funnel mouth 42 produces a second target area 58b (FIG. 5) smaller than the first target area 58a. For the purposes of this application, the “target area” of the funnel assembly 10 is defined as the area demarcated by the leading edge 62 of the mouth 42 (described below) as projected axially onto a plane positioned normal to the central axis 66 (see FIGS. 4 and 5).

Illustrated in FIGS. 2a-3c, and 6, the base frame 46 of the expandable funnel assembly 10 includes a substantially annular body 70 extending co-axial the central axis 66. The annular body 70 includes a top end 74, a bottom end 78 opposite the top end 74, and an inner surface 82 defining a first inner diameter 86. The inner surface 82 of the annular body 70 at least partially defines a channel 90 extending the axial length of the body 70 and open on both the top 74 and bottom 78 ends. In the illustrated embodiment, the channel 90 is substantially uniform in shape along its entire axial length and defines a channel area, defined as the cross-sectional area of the channel 90 taken normal to the axis 66. In some embodiments, the channel area 94 is the cross-sectional area of the channel 90 taken proximate the top 74 of the annular body 70.

When the funnel assembly 10 is installed on the tank 14, the annular body 70 extends at least partially through the inlet 26 such that the channel 90 forms a conduit through which fluid can enter the volume 22 (FIG. 1). In the illustrated construction, the annular body 70 is removably coupled to the wall 18 of the tank 14 by a set of exterior threads 98 sized to threadingly engage the interior threads 34 of the inlet 26. However, in alternative embodiments the base 46 may be coupled to the tank 14 with an adhesive. In still other constructions, the base 46 may be integrally formed with the walls 18 of the tank 14.

The base frame 46 also includes a flange 102 extending radially outwardly from the annular body 70 proximate the top 74 to produce an outer diameter. The flange 102 forms an annular slot 106 sized to receive an o-ring or seal 110 therein. When the base 46 is installed on the tank 14, the o-ring 110 is positioned such that it forms a seal between the flange 102 and the outer surface of the tank 14.

The base frame 46 also includes one or more activation lugs 114, each lug 114 extending radially inwardly from the annular body 70 and into the channel 90 (see FIGS. 2a, 7 and 8). In the illustrated construction, each activation lug 114 is positioned proximate the top 74 of the base 46 and is axially aligned with a corresponding funnel rod 154 of the funnel frame 50 (described below). In the illustrated embodiment, each activation lug 114 is separated from adjacent activation lugs 114 by a gap 122. In the illustrated construction, the base frame 46 includes four activation lugs 114, each corresponding to a respective one of the four funnel rods 118. However in alternative embodiments, more or fewer activation lugs 114 may be present.

In addition to interacting with the funnel rods 118, the activation lugs 114 of the base frame 46 also double as retaining members for securing the cap 54 to the base 46. More specifically, each activation lug 114 is configured to engage a corresponding locking lug 218 of the cap 54 (described below) such that the cap 54 cannot be axially removed from the base frame 46.

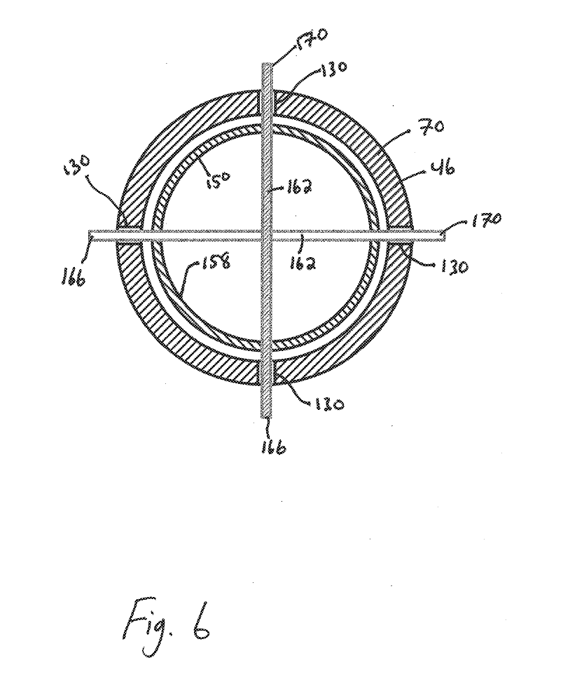

Illustrated in FIGS. 2a, 2b, and 6, the base frame 46 defines a plurality of guide grooves 130, each formed in and extending axially along the annular body 70 to create a first end 134, proximate the bottom 78 of the base 46, and a second end 138, proximate the top 74 of the base 46. When the funnel 10 is assembled, each guide groove 130 is sized to receive a respective end of a respective guide rod 162 therein (FIG. 6). In the illustrated embodiment, the base 46 includes four guide grooves 130, each spaced equally about the annular body 70; however in alternative embodiments, more or fewer grooves may be present.

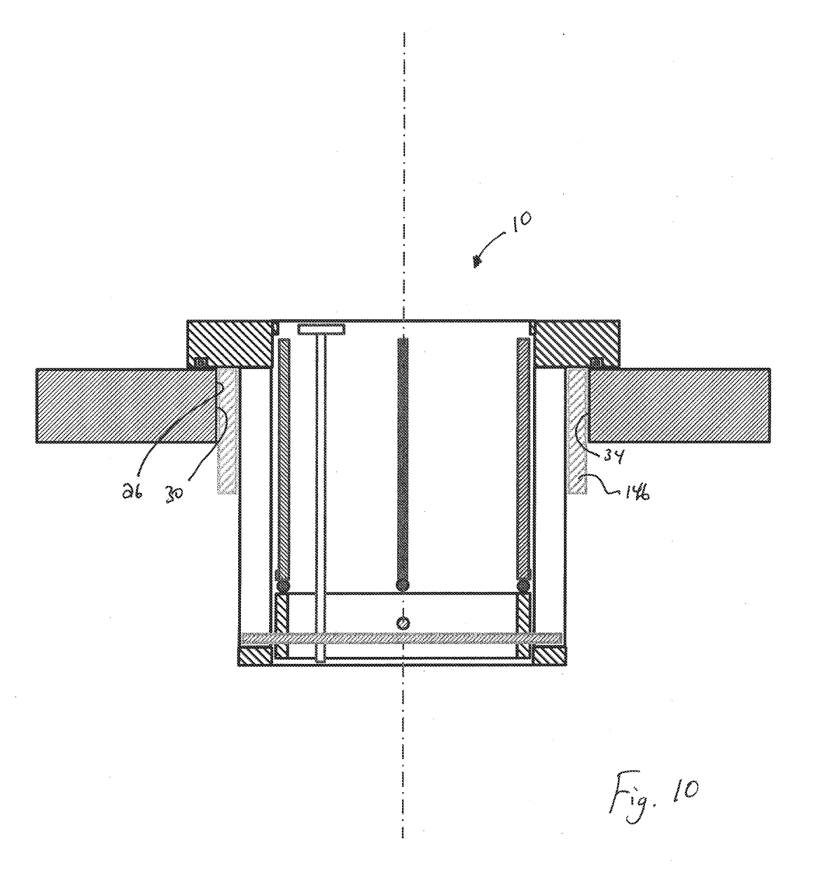

Illustrated in FIG. 10, the base frame 46 may also include an adaptor sleeve 146 for allowing a common sized base frame 46 to be installed on inlets 26 having different inlet diameters 30. More specifically, the adapter sleeve 146 reduces manufacturing costs by allowing a single funnel 10 design to be used in multiple tank configurations. Specifically, each sleeve 146 includes an inner diameter corresponding to the outer diameter of the base frame 46, and an outer diameter corresponding with the desired inlet diameter 30.

Illustrated in FIGS. 2a-3c, the funnel frame 50 of the funnel assembly 10 includes a carriage 150 movably coupled to the base frame 46, a plurality of funnel rods 154 pivotably coupled to the carriage 150, and the mouth 42. During use, the funnel frame 50 is movably coupled to the base frame 46 and adjustable between a deployed position (FIG. 2a), where the mouth 42 is positioned outside the channel 90 and produces a first target area 58a, and a stowed position (FIG. 3a), where the mouth 42 is positioned inside the channel 90 and produces a second target area 58b smaller than the first target area 58a.

Illustrated in FIGS. 2a-3c and 6, the carriage 150 of the funnel frame 50 is substantially cylindrical in shape, defining an outer diameter that substantially corresponds with the inner diameter 86 of the channel 90. The carriage 150 also defines an inner diameter at least partially forming a fluid passage 158. During use, the carriage 150 travels axially within the channel 90 between a first carriage position (FIG. 3a), proximate the bottom 78 of the base 46, and a second carriage position (FIG. 2a), proximate the top 74 of the base 46.

The carriage 150 of the funnel frame 50 also includes a pair of guide rods 162, each guide rod 162 passing through the carriage 150 to produce a first end 166 extending radially beyond the outer diameter of the carriage 150, and a second end 170 extending radially beyond the outer diameter of the carriage 150 opposite the first end 166. When the funnel frame 50 is coupled to the base frame 46, the first and second ends 166, 170 of each guide rod 162 are positioned within a corresponding guide groove 130 of the base frame 46 (FIG. 6). As such, the guide rods 162 position the carriage 150 co-axially within the channel 90 and guide the carriage 150 as it moves axially between the first and second carriage positions. More specifically, as the carriage 150 moves between the first and second carriage positions, each end 166, 170 of each guide rod 162 travels along the length of its respective guide groove 130 between the first end 166 and the second end 170, respectively.

Although the illustrated embodiment includes two guide rods 162 positioned substantially perpendicular to one another, in alternative embodiments more of fewer guide rods 162 may be used. In still other embodiments, the guide rods 162 may be replaced with radial lugs (not shown) extending radially outwardly from and formed integrally with the carriage 150. In such an embodiment, each radial lug would be positioned within a corresponding guide groove 130.

The funnel frame 50 also includes a plurality of funnel rods 154, each having a first end 174 pivotably coupled to the carriage 150, and a second end 178 opposite the first end 174. The funnel rods 154 provide rigidity to the mouth 42 of the funnel 10, helping maintain the mouth's shape against the force of fluids being poured into the funnel assembly 10. During use, each funnel rod 154 is pivotable with respect to the carriage 150 between a first position (FIG. 3b), where the second end 178 is positioned radially inward of the inner diameter 86 of the annular body 70, and a second position (FIG. 2b), where the second end 178 is positioned radially outside the inner diameter 86 of the annular body 70. In the illustrated embodiment, the funnel assembly 10 includes four funnel rods 154, each positioned equally about the carriage 150. However in alternative embodiments, any number of funnel rods 154 may be used depending upon the strength and desired shape of the funnel mouth 42.

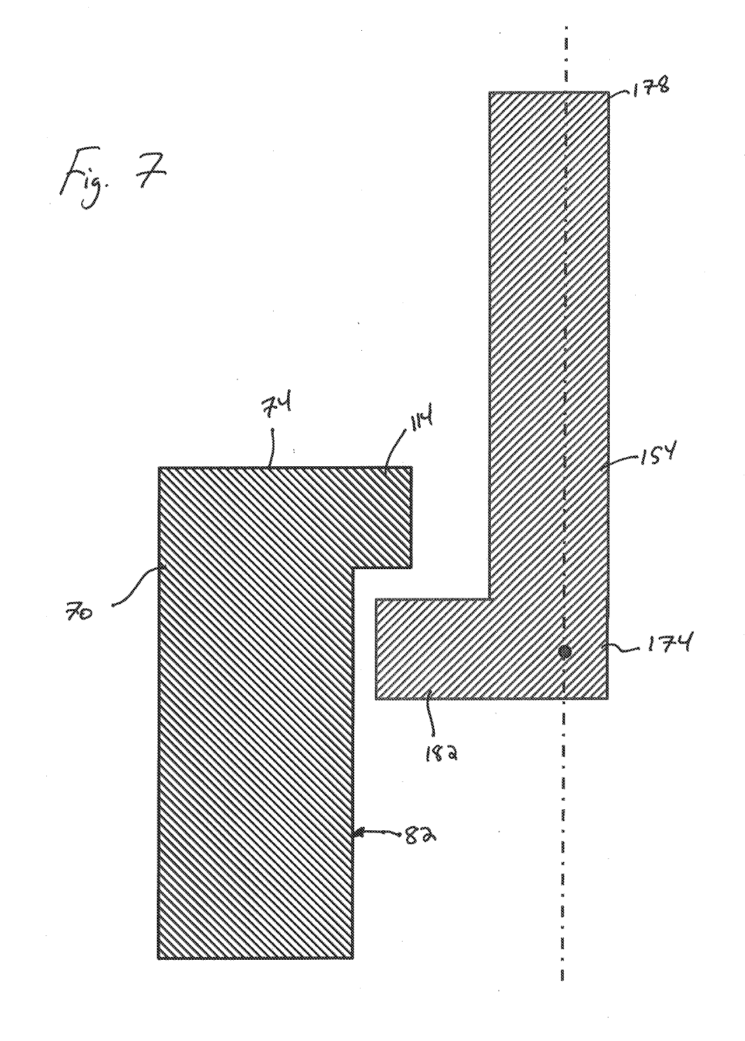

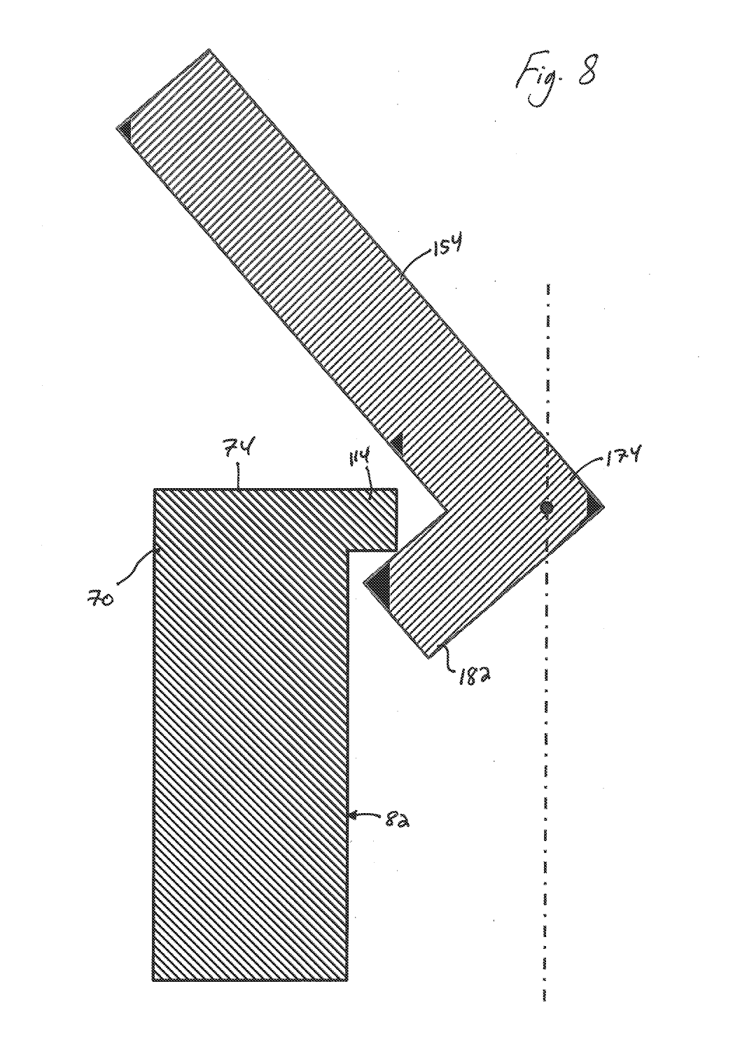

Each funnel rod 154 also includes a pivot protrusion 182 extending proximate the first end 174 and configured to engage a corresponding activation lug 114 of the base frame 46 (FIGS. 7 and 8). During use, each protrusion 182 contacts a corresponding activation lug 114 causing the funnel rod 154 to pivot with respect to the carriage 150 between the first position (FIG. 7) and the second position (FIG. 8). Specifically, as the carriage 150 moves axially upwardly toward the top of the base frame 46 (i.e., toward the second carriage position), the protrusion 182 contacts the underside of the activation lug 114 which in turn forces the funnel rod 154 to pivot toward the second position.

Illustrated in FIGS. 2a, 3a, 4 and 5, the mouth 42 of the funnel frame 50 is formed from sheet material that is flexible, impervious, and chemically inert with respect to the working fluid. The mouth 42 is formed in a generally frusto-conical shape having a leading edge 186, and a trailing edge 190 opposite the leading edge 186. When assembled, the mouth 42 is coupled to the funnel frame 50 with the leading edge 186 positioned proximate the second end 178 of the funnel rods 154 and the trailing edge 180 coupled to the inner diameter of the carriage 150. Specifically, each funnel rod 154 extends along and is coupled to the lateral surface of the mouth 42. During use, fluids poured into the mouth 42 flow, via gravity, toward the trailing edge 190 and into the fluid passage 158.

The overall shape and orientation of the mouth 42 is generally defined by the position of the funnel rods 154 with respect to the carriage 150. For example, when the funnel rods 154 are in the second position, the mouth 42 is pulled taut and takes on a downward-facing, rectangular-pyramid shape (see FIGS. 2a and 4). In this orientation (generally corresponding to the deployed configuration of the funnel assembly 10), the leading edge 186 of the mouth 42 is positioned axially above and radially outside the channel 90 to form the first target area 58a. More specifically, the leading edge 186 forms a substantially square shape with each edge being positioned outside the inner diameter 86 of the channel 90. In the illustrated embodiment, the first target area 58a is larger than the channel area 94.

In contrast, when the funnel rods 154 are in the first position, the mouth 42 is generally folded onto itself and sized to fit inside the channel 90 (FIGS. 3a and 5). In this orientation, (which generally corresponds to the stowed configuration of the funnel assembly 10), the leading edge 186 of the mouth 42 is positioned inside the channel 90 and forms the second target area 58b that is smaller than the first target area 58a. In the illustrated embodiment, the second target area 58b is also smaller than the channel area 94.

The funnel frame 50 also includes a handle 194 coupled to the carriage 150 and configured to allow the user to manipulate the position of the carriage 150 within the channel 90 without the need to place his or her hand in the channel 90 or contacting the mouth 42. The handle 194 of the illustrated embodiment includes a handle shaft 198, coupled to the carriage and extending axially therefrom to form a grip 202. In some embodiments, the handle shaft 198 is hollow allowing the handle 194 to act as a vent.

Illustrated in FIG. 3c, the cap 54 of the funnel assembly 50 includes a substantially disk shaped body 206 that is configured to selectively seal the top end 74 of the channel 90. The body 206 of the cap 54 includes an annular channel 210 that is sized to receive an o-ring 214 or other seal therein. When the cap 54 is in the locked configuration, the seal 214 is configured to contact the top 74 of the base 46 and form a seal therewith.

The cap 54 also includes a plurality of locking lugs 218, each extending from the body 206 to releaseably couple the cap 54 to the base 46 of the funnel assembly 10. During use, each locking lug 218 is configured to engage a respective activation lug 114 of the base frame 46.

To operate the collapsible funnel assembly 10, the funnel begins in the stowed configuration (FIG. 3c). When the funnel assembly 10 is in the stowed configuration, the carriage 150 is positioned proximate the bottom 78 of the base frame 46 in the first carriage position. Furthermore, each funnel rod 154 is in the first position allowing the mouth 42 to be positioned within the channel 90 and causing the mouth 42 to produce the second target area 58a (FIG. 5). Further still, the cap 54 of the funnel assembly 10 is installed on the base frame 46 sealing the top 74 of the channel 90.

To place the funnel assembly 10 in the deployed configuration, the user first rotates the cap 54 with respect to the base 46 until each locking lug 218 is positioned in a corresponding gap 122 between two adjacent activation lugs 114. Once the locking lugs 218 are positioned in a corresponding gap 122, the user axially removes the cap 54 from the base 46 opening the top 74 of the channel 90 (FIG. 2a).

With the cap 54 removed, the user grasps the grip 202 of the handle 194 and pulls in direction A. The force applied by the user onto the handle 194 causes the carriage 150 to move axially with respect to the base 46 toward the second carriage position. As the carriage 150 moves axially within the channel 90, the guide rods 154 move along their corresponding guide grooves 130 away from the first end 134 and toward the second end 138. Furthermore, the movement of the carriage 150 causes the funnel rods 154 and the mouth 42 to axially emerge from the top 74 of the channel 90.

When the carriage 150 approaches the second carriage position, the pivot protrusion 182 of each funnel rod 154 engages with a corresponding activation lug 114 (FIG. 7). As the carriage 150 continues to move axially toward the second carriage position, the contact between the pivot protrusions 182 and the activation lugs 114 cause each funnel rod 154 to pivot with respect to the carriage 150 away from the first position and toward the second position. Similarly, the pivoting motion of the funnel rods 154 cause the mouth 42 to begin to unfold.

Once the carriage 150 reaches the second carriage position, the funnel rods 154 have completed their pivoting motion and are in the second position (FIG. 8). As such, the mouth 52 is completely unfolded and producing the first target area 58a (FIG. 4). More specifically, the mouth 42 is displaced axially outside the channel 90 from the axial movement of the carriage 150 and is unfolded to produce the first target area 58a from the pivoting motion of the funnel rods 154. In all, the funnel assembly 10 is now in the deployed configuration (FIG. 2a).

With the funnel assembly 10 in the deployed configuration, the user may pour fluids into the mouth 42 of the funnel 10 where they will ultimately be directed into the volume 22 of the tank 14. Moreover, any air in the volume 22 that is displaced by the added fluid may be vented through the handle 194.

To stow the funnel assembly 10 after use, the user grasps the grip 202 of the handle 194 and applies force opposite direction A. The force causes the carriage 150 to move axially within the channel 90 away from the second carriage position and toward the first carriage position.

As the carriage 150 moves axially downwardly, each funnel rod 154 contacts the top 74 of the annular body 70 causing the rods 154 to pivot with respect to the carriage 150 toward the first position. As such, the mouth 42 begins folding onto itself. The user continues to apply force until the carriage 150 has reached the first carriage position, the funnel rods 154 have reached the first position, the leading edge 186 of the mouth 42 is positioned within the channel 90, and the mouth 42 produces the second target area 58b. When this has occurred, the funnel assembly 10 has returned to the stowed configuration (FIG. 3a).

With the funnel 10 in the stowed configuration, the user may re-install the cap 54 onto the base 46. To do so, the user axially aligns each locking lug 218 with a corresponding gap 122. The user then axially introduces the cap 54 until the body 206 contacts the top 74 of the base 46. The user then rotates the cap 54 with respect to the base 46 until each locking lug 218 engages and is retained by a corresponding activation lug 114. With the cap 54 in place, the top 74 of the channel 90 is sealed (FIG. 3c).

FIGS. 9a and 9b illustrates a second embodiment of the base frame 46′ of the present invention. The second embodiment of the base frame 46′ is substantially similar to the base frame 46 described above. As such, only the differences between the two will be described herein. For the purposes of this description, all similar elements will be given similar element numbers with the addition of a prime symbol (“′”). The second embodiment of the base frame 46′ is configured to be threadably attached to a fluid tank 14′ having a threaded nipple 38′, and a pre-existing cap 500′ configured to threadingly couple with the nipple 38′ (FIG. 9a). The base frame 46′ is configured such that it can be installed on the nipple 38′ without modification to the tank 14′ while providing external threads 504′ on which the pre-existing cap 500′ can be used.

Illustrated in FIG. 9b, the body ‘508 of the base frame 46’ is substantially cylindrical in shape and includes an outer annular wall 512′ configured to threadingly engage the external threads of the threaded nipple 38′. The base frame 46′ also includes an inner annular wall 516′ co-axial with and positioned radially inward of the outer annular wall 512′ to define an inner diameter 86′ and produce a channel 90′ analogous to the channel 90 of the base frame 46. Furthermore, the base frame 46′ includes an adaptor 520′ extending axially from the inner annular wall 516′ to form the external threads 504′. In the illustrated embodiment, the external threads 504′ produce the same thread diameter as the external threads 514′ of the threaded nipple 38′.

To install the base frame 46′ onto the tank 14′, the user removes the pre-existing cap 500′ from the nipple 38′. With the cap 500′ removed, the user threadingly installs the base frame 46′ onto the nipple 38′. Finally, the user may threadingly install the pre-existing cap 500′ onto the annular wall 512′ of the base 46′.

Various features and advantages of the invention are set forth in the following claims.

1. An expandable funnel assembly for use with a fluid storage tank defining a volume and having an inlet in fluid communication with the volume, the expandable funnel assembly comprising:
a mouth coupled to the tank and operable to direct fluids to the inlet, the mouth being adjustable between a first configuration, wherein the mouth provides a first target area, and a second configuration, wherein the mouth provides a second target area different than the first target area.

2. The expandable funnel assembly of claim 1, wherein the inlet defines an inlet area, wherein the first target area is larger than the inlet area, and wherein the second target area is smaller than the inlet area.

3. The expandable funnel assembly of claim 1, wherein the inlet defines an axis, the expandable funnel assembly further comprising a carriage axially moveable with respect to the inlet, and wherein the mouth is adjustable between the first configuration and the second configuration based at least in part on the movement of the carriage with respect to the inlet.

4. The expandable funnel assembly of claim 1, wherein the mouth includes a leading edge, and wherein the mouth is movable with respect to the inlet between a stored position, wherein the leading edge is positioned within the volume, and a deployed position, wherein the leading edge is positioned outside the volume.

5. The expandable funnel assembly of claim 1, wherein the mouth is formed from flexible sheet material.

6. An expandable funnel assembly for use with a fluid storage tank defining a volume, the expandable funnel assembly comprising:
a frame couplable to the tank and defining an axis and a channel in fluid communication with the volume, the channel having a top end and a bottom end opposite the top end;
a carriage coupled to the frame and axially moveable within the channel between a first position, proximate the top of the frame, and a second position proximate the bottom of the frame; and
a mouth coupled to the carriage and adjustable between a first configuration, wherein the mouth provides a first target area, and a second configuration, wherein the mouth provides a second target area smaller than the first target area.

7. The expandable funnel of claim 6, wherein the mouth is adjustable between the first configuration and the second configuration based at least in part on the position of the carriage with respect to the frame.

8. The expandable funnel of claim 6, wherein the frame includes a pivot protrusion operable to engage the mouth and adjust the mouth between the first configuration and the second configuration.

9. The expandable funnel of claim 8, wherein the pivot protrusion is positioned proximate the top end of the channel, and wherein the pivot protrusion engages the mouth when the carriage is in the first position.

10. The expandable funnel of claim 6, wherein the mouth includes a leading edge, and wherein the mouth is movable with respect to the frame between a third position, wherein the leading edge is positioned inside the channel between the top end and the bottom end, and a fourth position, wherein the leading edge is positioned outside the channel.

11. The expandable funnel of claim 6, wherein the channel defines a channel area, wherein the first target area is larger than the channel area, and wherein the second target area is smaller than the channel area.

12. The expandable funnel of claim 6, further comprising an adaptor ring, and wherein the adaptor ring includes an inner diameter substantially corresponding an outer diameter of the frame and an outer diameter substantially corresponding to an inner diameter of an inlet of the fluid storage tank.

13. The expandable funnel of claim 6, further comprising a handle coupled to at least one of the carriage and the mouth and axially movable therewith.

14. The expandable funnel of claim 13, wherein the handle includes a vent extending therethrough.

15. The expandable funnel of claim 6, further comprising a cap removably coupled to the frame and configured to selectively seal the top end of the channel.

16. The expandable funnel of claim 6, further comprising a plurality of funnel rods each having a first end pivotably coupled to the carriage and a second end opposite the first end, wherein each funnel rod is pivotable with respect to the carriage between a fifth position, wherein the second end is positioned radially inside the channel, and a sixth position, wherein the second end is positioned radially outside the channel.

17. The expandable funnel of claim 16, wherein movement of the carriage from the second position to the first position causes each funnel rod to pivot from the fifth position to the sixth position.

18. An expandable funnel assembly for use with a fluid storage tank defining a volume and having a threaded nipple in fluid communication with the volume, where the threaded nipple defines a first thread diameter, the expandable funnel comprising:
a frame removably couplable to the fluid storage tank, the frame having a first wall configured to threadingly engage the threaded nipple and a second wall forming external threads having a second thread diameter that is substantially similar to the first thread diameter; and
a mouth coupled to the frame and adjustable between a first configuration where the mouth provides a first target area, and a second configuration, wherein the mouth provides a second target area different than the first target area.
